(19) United States
(12) Patent Application Publication
(10) Pub. No.: US 2024/0273060 A1
(43) Pub. Date: Aug. 15, 2024

(54) MICRO-FORUM NETWORK

(71) Applicant: INNER-MACHINATIONS, INC., Ponchatoula, LA (US)

(72) Inventor: Arpana Thakur MANSFIELD, Dublin, CA (US)

(73) Assignee: INNER-MACHINATIONS, INC., Ponchatoula, LA (US)

(21) Appl. No.: 18/107,656

(22) Filed: Feb. 9, 2023

(51) Int. Cl. G06F 16/11; H04L 9/40

(52) U.S. Cl. CPC G06F 16/122; H04L 63/0876; H04L 67/55

(57) ABSTRACT

Disclosed herein are system, method, and computer program product embodiments for a non-hierarchical micro-forum network to receive a request message to subscribe to an originating node of a first micro-forum operative within a micro-forum network configured with a first topic, wherein the first micro-forum is configured with one or more rules to at least process the request message to subscribe. The embodiment further operates by receiving a topic message to be transmitted to a subscriber recipient node within a second micro-forum operative within the micro-forum network. The topic message comprises modified content from the first topic and is transmitted based on transmission parameters for the originating node to transmit the topic message to the recipient node and acceptance parameters of the subscriber recipient node. The topic message is retained in the second topic of the subscriber recipient node.

### BACKGROUND

### Field

This disclosure is generally directed to creation of message boards, and more particularly to topic-based forum structures.

### Background

There are many message board products that have been operating for years. However, message boards are often hijacked in favor of alternative topics, personal agendas, misinformation, or unwanted divisive discussions.

Current person-to-person message boards, e.g., micro-blogging systems, may require persistent removing of unwanted content by a creator. Also, current person-to-topic message boards require moderators to continuously scrub postings for relevancy. In addition, users may need to report unwanted content to administrators and moderators. Because message boards may require a platform-based monitoring system, an existing architecture may not be able to properly or quickly eliminate unwanted content and postings.

### SUMMARY

Provided herein are system, apparatus, device, method and/or computer program product embodiments, and/or combinations and sub-combinations thereof, for a micro-forum network. In some embodiments, the technology described herein provides for a machine-implemented non-hierarchical online broadcasting network consisting of user-owned forums (“micro-forums”) and subscribers.

### BRIEF DESCRIPTION OF THE DRAWINGS

The accompanying drawings are incorporated herein and form a part of the specification.

FIG. 1 is a diagram of an example micro-forum, according to some embodiments.

FIG. 2 is a diagram of an example micro-forum network, according to some embodiments.

FIG. 3 is another example diagram of a micro-forum network, according to some embodiments.

FIG. 4 is another example diagram of a micro-forum network, according to some embodiments.

FIG. 5 is another example diagram of a micro-forum network, according to some embodiments.

FIG. 6 is an example flow diagram of a micro-forum network, according to some embodiments.

FIG. 7 is an example diagram of micro-forum platform, according to some embodiments.

FIG. 8 is an example diagram of a micro-forum object, according to some embodiments.

FIG. 9 is another example diagram of a micro-forum object, according to some embodiments.

FIG. 10 is a flowchart of a micro-forum process, according to some embodiments.

FIG. 11 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a micro-forum network. In some embodiments, the technology described herein provides for a machine-implemented non-hierarchical online broadcasting network consisting of user-owned forums (“micro-forums”) and subscribers.

In some embodiments, each micro-forum is controlled and maintained by its owners. Owners have real-time control of the forum topics, posted content and its life-time, validation rules for incoming and outgoing messages, organization of data and subscriber access rights.

In some embodiments, the forum topics are not predefined or collaborated upon. Forum topics may be specifically created by the micro-forum owner to meet their personal needs and are only subject to the networks' terms of use.

In some embodiments, a forum topic serves the owners as a repository and collaboration space of related topic specific content pertinent to its owners. The micro-forum may also be implemented as a gateway to regulate messages entering and exiting the forum topic. As a gateway, the forum topic enforces its owners' subscriptions, network terms of use and conditions, and its owners' acceptance criteria before accepting messages.

In some embodiments, a micro-forum may evaluate its owners' transmission requirements before allowing messages to be transmitting to its subscribers in the network.

In some embodiments, a micro-forum can exist solely as a content repository and be accessible without any forum topics or any subscriptions or subscribers.

In some embodiments, dependencies and interdependencies of micro-forums and forum topics direct notifications and global messages to a target audience without any personal user data or user analytics.

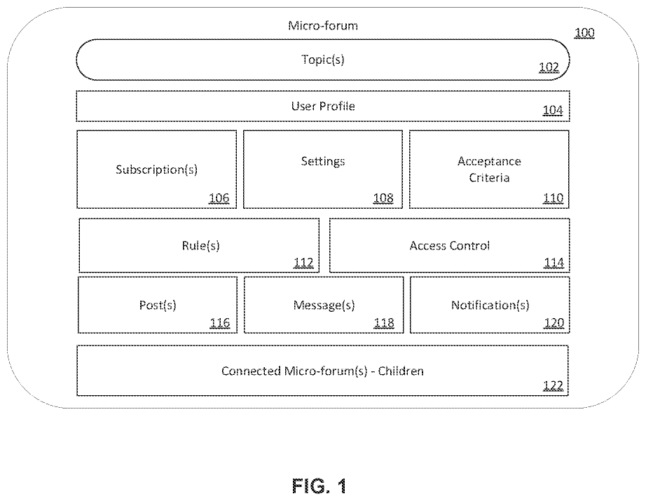

FIG. 1 is a block diagram of a micro-forum 100, according to some embodiments. Micro-forum 100 may be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 1, as will be understood by a person of ordinary skill in the art.

Micro-forum 100 shall be described with reference to FIG. 1. However, micro-forum 100 is not limited to this example embodiment.

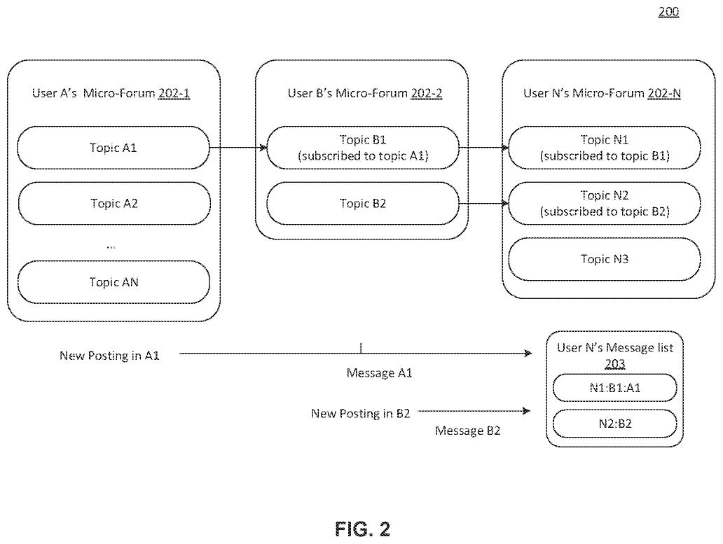

Unlike conventional forums, a micro-forum 100, as described herein, refers to a private forum where an owner/user (hereafter user) is the content creator or controller. The content created by a micro-forum user related to topics 102 may be managed as the primary micro-forum or may be separated by the user into one or more topics 102 and managed as a set of connected child micro-forums in connected micro-forum(s) 122. The micro-forum 100 is subsequently operative as part of a non-hierarchical network of interconnected micro-forum topics. These topics 102 may be implemented as, but not limited to, plain text, Hypertext Markup Language (HTML), font icons, video, audio, links, etc. These topics 102 are then made available on a subscription basis, where other micro-forum owners may request and receive an acceptance for a subscription(s) 106 to connect their micro-forum to a specific topic. Their subscription will form a communication path, from one or more of their micro-forum topics to a subscribed to topic (i.e., topic-to-topic or topic-to-subscriber micro-forum). As additional users of other micro-forums subscribe, based on acceptance criteria 110, they will be interconnected in a non-hierarchical micro-forum network structure (e.g., as shown in FIGS. 2-6). New or updated content added to a subscribed micro-forum topic will be transmitted along these one or more communications paths to each subscriber of that topic, for example, as messages 118, based on the acceptance criteria 110 set for each subscribed micro-forum and subscriber micro-forum. Acceptance criteria 110 may include, but is not limited to, checks like “is subscriber present on a white-list?”, “is the message sent from a subscriber?”, “is the message from a specific topic?”, “is the subscriber not present on a black-list?”, quantity of content created required for user met, “does subscriber have access rights required?”, “is subscriber pre-approved?”, “does the subscriber have an invitation?”, “is the micro-forum accepting new subscriptions?”, “is the subscriber in good standing with the micro-forum?”, “is the subscriber rating required met?”, “is the subscriber currently blocked by the micro-forum?”, “is the account creation age requirement met?”, to name a few.

As will be described in greater detail hereafter, in some embodiments, these messages 118 may be new content, updated content or notices, such as, but not limited to, topic threads. In some embodiments, the messages may include links to additional content. In a non-limiting example, the links may comprise attachments, executable software code, new applications (i.e., apps), software updates or notifications associated with software updates. However, in the sender/recipient relationship, the recipient (i.e., subscriber) ultimately controls whether a message reaches its destination. For example, the receiving micro-forum may establish their own rules that accept or prevent messages having keywords or subjects that indicate their own specific interests for this topic. In a non-limiting example, as a subscriber for Topic A, I am only interested in original content that is in a specific thread of a larger topic (e.g., specific theme, geography, demographic, product, model, event, etc.). For example, for a topic of “live music events”, I may only accept new content directed to live events in my local geography (e.g., town, county, state, region, etc.). In another example, I may only receive updates for a specific music genre (e.g., pop) or a specific musical act (e.g., band).

In some embodiments, a micro-forum 100 may be configured as a user page consisting of, but not limited to, forum topics 102 created by the user and further may include topic related data. The topic related data may include, but is not limited to, a forum topic page, topic name, topic description(s), origination or created date, multiple levels of topic specificity or customization of the topic, to name a few. For example, the topic may be “classic cars” with a focus on a specific type of car or brand. In addition, multiple levels of specificity may be included in the name or description or both. For example, building on the above example, the topic could be Classic Cars: Ford: 1960-1980.

User profile 104, may include user profile related data, such as user name, historical activity (such as list of topics that the micro-forum owner has provided original content to, topics that they follow, etc.), an image/photo, a rating, to name a few.

As previously described, content originated by the user of the micro-forum is provided for public consumption as a topic 102 with a subscription 106 required to view/receive original content posts 106. In a non-limiting example, a subscriber may initiate a subscription request to a micro-forum based on any of a search of a user or owner name, micro-forum name, topic, keyword, or in response to a current micro-forum's advertisement of one or more topics or an invitation, to name a few. A subscriber may subsequently configure their own personal micro-forum to have new content pushed to their micro-forum, for example, as messages to a topic. In some embodiments, the owner of the micro-forum may set-up rules 112 that apply acceptance criteria 110 for visiting users and subscribers, as well as, when transmitting or receiving content (e.g., messages) from another micro-forum. Rules 112 may include, but are not limited to, filtering content for specific keywords, topic, etc.; filtering users with specific rating, status, accounts, etc.; preventing messages from being forwarded or commented on; marking messages with a privacy level setting (such as, private or visible to specific users); redirecting messages to specific topics; flagging messages with specific values or tags, etc. Rules may also be set by the network level to meet terms and conditions set for all messages and users; such as, but not limited to, meeting specific moral, ethical or otherwise acceptable social conventions when creating a message or account, preventing unacceptable files from being uploaded to a site (e.g., micro-forum topic node), stopping abusive behavior, such as, rapid creation of messages by one user, attempting to circumvent a current subscription block, etc.

Settings 108 may include a collection of metadata based on any of the topic profile related data, user profile related data, device related data, interface related data (such as, but not limited to, colors, fonts, themes, images, etc.)

Access control 114 may include, but is not limited to, granting or denying access at the user, group, or role level; granting the ability to read, edit, delete, or add modifications (reply or comment) on content; granting ability to interact with owner or other users; each content provider and subscriber manually or automatically engaging rules preventing transmission or reception of content that they do not approve of (e.g., outside the intended topic).

Content originated by the user of the micro-forum 100 is provided for public consumption as a topic 102 discussion board, with access 114, to view posts 116 (content). Posts 116 may be, but are not limited to, text, embedded images, links to internet and media content, audio, video, multi-media, etc. While, in most cases, posts 116 can be interchangeable with messages 118, the distinction is that a post is committed to the discussion board. Not all messages received by a micro-forum will become a post on that micro-forum. For example, some may come as notifications. For example, a message to a subscriber that they have been “unsubscribed” would not be posted to their micro-forum topic as an updated content message.

For subscribers of the micro-forum, with a subscription 106, a message 118 is communicated across a communication network each time an update is posted or as an aggregated group of updates by time (e.g., each hour, day, etc.). These messages may include, but are not limited to, content to post (text, linked or embedded images, links to internet and media content, etc.), file attachments, and links to other content in the network (such as, messages and comments from other users or systems). Micro-forum topic nodes are dynamic structures that act as relay points passing these messages 118 through the network, as well serving as a repository for messages 118. In some embodiments, messages travel from topic node to topic node rather than from users to users. This allows messages to stay “on topic” and relevant as they pass through the network.

In some embodiments, duplicate messages that take different routes through the network are not posted to a micro-forum topic that has previously received the same message. For example, a “Micro-forum B” may subscribe to “Topic A” located within an originating “Micro-forum A” directly or indirectly through another “Micro-forum C” that also subscribes to the original Micro-forum A. In this scenario, the same message may be delivered to Micro-forum B through multiple paths or micro-forums. However, in some embodiments, a later arriving duplicate message, sent on the multiple paths, is prevented from posting on Micro-forum B.

Micro-forums may communicate various message, status, and control or subscription information as Notifications 120. These notifications may include, but are not limited to, requests from another micro-forum user to be a subscriber, notice of acceptance to a previous subscription request, requests by subscribers to cancel a subscription 116, notice of new messages being received from micro-forum subscribed to by the user, notice of new message received from an allowed user, notice of successful or unsuccessful message distributions to subscribers, notice of alerts and messages from the network or approved users, notice of changed impacting a rule, notice of subscription status changes 112, to name a few.

As micro-forums 100 are private spaces controlled by their respective owners (e.g., by rules 112), the maintenance of the micro-forum and topic content is the responsibility of the users who best know and understand the topic. In some embodiments, remediation for unwanted content may include, but is not limited to, setting rules that may block or hide unwanted content.

A list of micro-forums that the current micro-forum owns or has been granted ownership rights to (i.e., co-owner) as a listing of connected micro-forums 122 (children) may include their micro-forum display information from settings (such as, name, description, owner name, style, post template/type etc.), filtering and data-mining values from settings (such as, micro-forum type, category, region, keywords, etc.), routing information from subscriptions and rules (e.g., subscribers, subscriptions, incoming rules, outgoing rules etc.), access rights (e.g., privacy level, co-owners, access control, etc.), to name a few. For example, if a user had a topic called “classic cars” and wanted to additionally include trucks, motorcycles, etc. Instead of requiring a user to generate a new micro-forum and lose their posting history, the user can create a new topic called “classic vehicles” and move the previous topic “classic cars” inside it to create a new micro-forum that now may include content on trucks and motorcycles.

In some embodiments, messages broadcast to all subscribers may have variable lifespans or expirations depending on the value and continued relevancy of the content to the user, micro-forum and network. These messages may remain accessible for the earliest relevant time period specified, such as, but not limited to, a specific age of the message (in minutes, hours, days, weeks, months, or years), a date specified by the user or micro-forum, a specific retention period designated by the network, etc. It may be possible to override or ignore some expiration dates due to network terms of use. In a non-limiting example, a message regarding an event may be set to expire after the event date by the user, after 30 days by the micro-forum, after 2 years by the micro-forum, etc., resulting in the message expiring after whichever date comes first. In some embodiments, the network may require the 2-year retention period to supersede other lifespans; in which case, the event date set by the user and 30 days set by the micro-forum may be ignored.

FIG. 2 is a flowchart for a micro-forum network 200, according to an embodiment. FIG. 2 may be performed by processing logic that can comprise hardware (e.g., circuitry, dedicated logic, programmable logic, microcode, etc.), software (e.g., instructions executing on a processing device), or a combination thereof. It is to be appreciated that not all steps shown may be needed to perform the disclosure provided herein. Further, some of the steps may be performed simultaneously, or in a different order than shown in FIG. 2, as will be understood by a person of ordinary skill in the art. In addition, micro-forum network 200 will be described at a high level to provide an overall understanding of flow of content of a micro-forum from topic node-to-node. Greater detail will be provided in the figures that follow.

In some embodiments, a micro-forum network 200 may be configured on one or more separate or interconnected computing devices. These computing devices may include, but are limited to, a server device, a plurality of interconnected server devices, a mobile device (e.g., smartphone, tablet, laptop, wearable device, etc.) or display devices, although other devices capable of processing data are contemplated without departing from the scope of the technology described herein. For example, micro-forum network 200 may be configured to include user interfaces for data entry/output. Data input user interfaces (UI) may render various graphical user interfaces, such as a data entry templates.

In a non-limiting example, a plurality of micro-forums 202(1-N) are interconnected based on subscriptions. As shown, User A's micro-forum 202-1 may include topics that User A is personally interested in posting about, such as Topics A1, A2 . . . AN. User B operates their own private micro-forum 202-2 that may also include topics that the user is personally interested in posting about. User B may subscribe to topics located within any other micro-forum (or within their own micro-forum). A subscription assumes that a subscribed to micro-forum accepts their subscription request and messages between their micro-forums adhere to the transmission rules of the respective micro-forums. For example, User B's micro-forum 202-2 may have a Topic B1 that User B wants to receive content from Topic A1, for example, based on same or similar topic names or descriptions, keywords, etc. or a relationship as determined by User B. In this example, User B subscribes Topic B1 from micro-forum 202-2 to User A's micro-forum 202-1 Topic A1 so that they may follow that specific topic. As shown, Topic B1 will, upon creation of a successful subscription, receive any updates posted within Topic A1, for example, as Message A1. User N may also be interested in a same or similar topic and therefore they subscribe their Topic N1 to User B's micro-forum Topic B1. In this example, User N also receives Topic A1 updates through their Topic B1 subscription. Also, in this arrangement, User B's Micro-forum 202-2 acts as both a repository for Topic A1 posts as well as a relay to User N's micro-forum 202-N, Topic N1. As such, User N gains a benefit of User A's posts without having to be aware that User A's micro-forum 202-1 or Topic A1 even exists. Alternatively, or in addition to, User N may also subscribe directly to one or more topics on User A's micro-forum 202-1.

User N's micro-forum 102-N, may simultaneously subscribe to separate or different topics provided by User B, such as Topic B2. This subscription has a separate communication path than the first subscription from N1 to B1 and will receive updates from Topic B2 as Messages B2. As this example reveals, the micro-forum is connected by topics, not by user. This structure reflects a fundamental difference from current message board forums that are “user” centric. For example, these prior forums operate by a post from a first user (e.g., originator) and then subsequently build the forum by a series of posts by a plurality of other users. For these forums to keep content focused on the current topic requires one or more controllers of the message board forum to cull off-topic posts. As posts can accumulate very quickly, this becomes an arduous task performed at irregular time periods, or not at all. The technology as described herein eliminates this culling activity burden on the forum owner.

In some embodiments, a subscriber may offer potential content for the micro-forum topic that they subscribe to. For example, they may offer comments (e.g., as messages) back to the owner of the micro-forum topic that they subscribe to. However, unlike current message boards described hereto before, it is up to the individual micro-forum owners, not a message board controller, to post or decline this content for the corresponding micro-forum topic or to edit existing content to at least partially reflect this potential content. In addition, as previously described, the owner of the micro-forum may set-up rules that dictate whether messages or content are sent, received, posted, updated or included as a modification to existing content.

In some embodiments, as previously described, a message may take unique and multiple routes between sender and recipient. Successful routes represent a trusted chain of communication and a target audience for the message. Because topic nodes act as repositories for messages, failed routes may still be accessible by the potential recipient through searches, suggestions and other trusted chains. For example, as shown, User N relies on User B for Topic A1 updates, but could subscribe directly to User A's micro-forum 202-1 or alternatively, to any other micro-forum that subscribes to Topic A1.

In some embodiments, a micro-forum network builds a communication routing structure between topic nodes which is mined for dependencies, exploration opportunities and change impact (for example, discovering hidden dependencies and relationships). Unlike conventional forums and person-to-person message boards, topic nodes, not users, are the focal points of how data is stored and interrelated; therefore data mining does not require user information or usage history. For example, a data mining process can analyze Topic A1 “Custom fishing lures” connections and discover User N's Topic N1 “Custom jewelry”. User N is a trendy custom jewelry maker who specializes in creating pieces using fishing lure and components. As a result of this analysis, User A may create a new Topic A2 “Hooked on Fashion” to reach out to User N and Topic N1 subscribers to create unique custom lures specifically designed for jewelry. The mining process does not require User N's friend list or browsing history, but mines to determine how User N's interests align with User A; the micro-forum already knows the commonality between the two users.

At least one technical solution provided by the technology described herein is an ability to rapidly expand a network of micro-forums without structuring it as a hierarchy dependent from the original source. For example, any micro-forum can connect, by subscription, to any micro-forum and gain access to topics by directly or indirectly connected to the original source. This loosely coupled network structure allows quick dissemination of topic-based original content along this ever-expanding network, while staying on topic and preventing someone from hijacking the original messaging. This technical solution improves the computer network itself. Another technical solution is preventing hijacking of content based on the micro-forum subscriber controlling content changes to their topic by controlling whether messages are received by their topics based on their own rules. In other words, each micro-forum controls who receives their content and what content they receive. This technical solution also improves the computer network itself by controlling content distribution.

In some embodiments, the messages may be delivered between nodes via a network and associated with a network-enabled data input program/application. The network may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network and/or a combination of these or other types of networks.

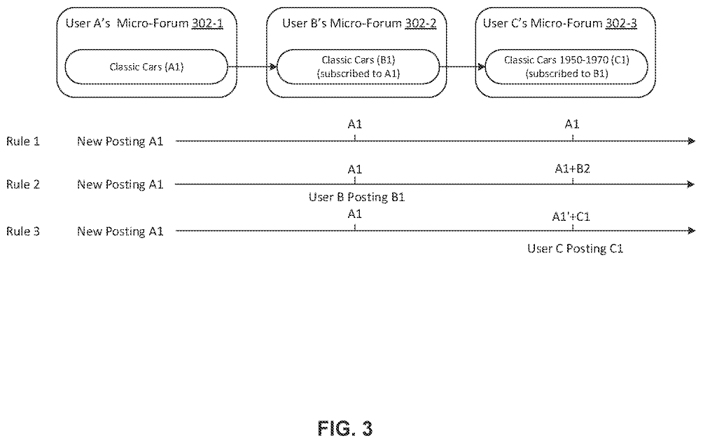

FIG. 3 is a flowchart for a micro-forum network operation, according to an embodiment. It is to be appreciated that not all steps shown may be needed to perform the disclosure provided herein. Further, some of the steps may be performed simultaneously, or in a different order than shown in FIG. 3, as will be understood by a person of ordinary skill in the art.

In a non-limiting example, a plurality of micro-forums 302(1-3) with same or similar topics of classic cars are interconnected based on subscriptions. As shown, User A's micro-forum 302-1 may include a topic “classic cars” that user A is personally interested in posting about. User B operates their own private micro-forum 302-2 that may also include a same or similar topic “classic cars” that user B is personally interested in posting about. User B may subscribe to User A's “classic car” topic as a way to build their same or similar topic. The subscription assumes that User A's micro-forum accepts their subscription request. However, each micro-forum may establish rules for receiving and sending content (e.g., messages). Rules may include, but are not limited to filters (e.g., by keyword, topic, longevity, rating, historical performance, etc.). For example, User B's micro-forum 302-2 may have a topic “classic cars” that aligns with “classic cars”, by same or similar topic names or descriptions, keywords, etc. As shown, Topic B1 will, upon subscription, receive any updates posted within Topic A1, as Message A1. User C may be interested in a same or similar topic and therefore they subscribe their topic C1 “classic cars 1950-1970 to User B's micro-forum topic B1.

This embodiment is shown with three different example rule scenarios. However, a subscriber may establish any number of rules to accept or decline incoming content messages. In addition, any combination of rules is within the scope of the technology described herein. Example Rule 1, directs all downstream micro-forums to only receive, store and relay Topic A1's messages. This scenario may represent situations where feedback or discussions are discouraged or counter-productive, such as, announcements and alerts. In this arrangement, downstream subscribers will post Topic A1 messages, without being able to add any modifications to the original posts. However, User C will receive each Topic A1 message forwarded inside a Topic B1 wrapper message and therefore, may filter both Topic A1 messages or the Topic B1 wrapper for their content related to the topic of classic cars 1950-1970. For example, they may establish a rule that uses keywords of year or model, topic name, content of post, etc. to filter incoming content. Example Rule 2, allows downstream micro-forums to add to the original Topic A1 and Topic B1 posts. As shown, User B adds new content (for example, a comment) to Topic A1 as message B2. User C's micro-forum will receive message B2 containing Topic A1's original message plus Topic B1's comment. User C would have the option to add a response to Topic A1's original message and/or Topic B1's comment and forward both Topic B1's and Topic C1's responses to their subscribers and so on. Topic A1 would also include both User B and User C comments on original post and to subscribers. In this arrangement, on-topic messaging can be additive or cumulative in nature and therefore ever expanding and encourage on-topic user interactions. In an example Rule 3 scenario, A1 may not allow content modifications to direct subscribers (e.g., User B), but User B's rules do allow downstream modifications. In this arrangement, User C would still receive the B2 message and may continue to filter on the forwarded Topic A1 message (as in Rule 1). However, they would only be able to add a response to the B2 message (i.e., the User B's comments). As a result, only User B and User C and their subscribers would see User C's response. Topic A1 and its subscribers would not include User C's response, unless they were Topic B1 or Topic C1 subscribers as well. This scenario demonstrates User A's ability to reduce the noise in Topic A1, while allowing side discussions in other micro-forums. The technology disclosed herein is not limited to these example rule scenarios.

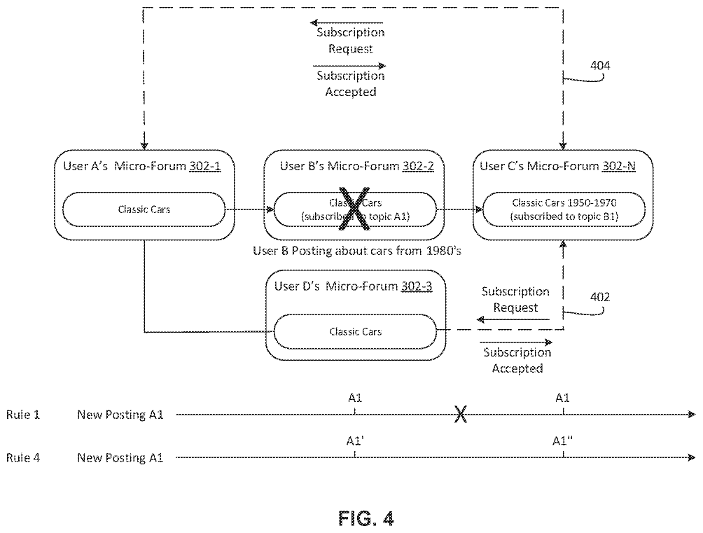

FIG. 4 is a flowchart for a micro-forum network operation, according to an embodiment. It is to be appreciated that not all steps shown may be needed to perform the disclosure provided herein. Further, some of the steps may be performed simultaneously, or in a different order than shown in FIG. 4, as will be understood by a person of ordinary skill in the art.

Previously described Rule 1, required all downstream micro-forums to only receive, store and relay topic A1's messages. In this arrangement, downstream subscribers will post A1 messages, without being able to add to the original posts. However, in this scenario, if User B's interests have subsequently changed and they delete their “classic cars” topic, no subscriptions to User B's “classic cars” topic are valid anymore and User C will receive no additional messages beyond message A1 from Topic A1 from User B. In some embodiments, User C may receive a notification making them aware there is a problem with their filter regarding User B. However, if there is exists an alternate path from Topic A1 to User C, that path will automatically engage and provide Topic A1 messages to User C; however, some changes to filters may be required as the source has changed. If an alternate path does not exist and User C is still interested in receiving A1 content, they may subsequently subscribe to Topic A1 directly or to any other micro-forum that also follows Topic A1, which can be found by searching by topic, theme, keywords, etc. As shown, User C subscribes 402 to the same topic “classic cars” found on User D's micro-forum 302-3, who subscribes 404 to the originator of the topic “classic cars”—User A's micro-forum 302-1. Regardless of the method chosen, once User C reestablishes the connection to Topic A1, the connection is automatically reestablished for all their downstream subscribers. This scenario shows how the micro-forum network can be pruned and repaired as a whole as users maintain their individual micro-forums.

In an example Rule 4 scenario, User A creates a rule for Topic A1 that allows limited modifications by subscribers when a received message is displayed, for example, but not limited to, color theme and font style. User B creates a rule to change any arriving message from Topic A1 to have a black font. Any messages from Topic A1 passing through Topic B1 are wrapped in a message from Topic B1 indicating the immediate source of the message (e.g., Topic B1 is forwarding the attached message from User A's Topic A1) and the linked message from Topic A1 will be displayed with a black font. User C will receive the modified message from Topic B1, but as a non-subscriber to Topic A1, will not have the ability to further customize the forwarded Topic A1 message. However, if allowed, User C can modify the appearance of the Topic B1's wrapper message. Other Topic A1 subscribers will receive Topic A1's message, unaltered by Topic B1's changes, and may apply their own customization to the message.

In a second example Rule 4 scenario, User B creates a rule that takes any arriving message from Topic A1 with the subject matter set to “Years 1950-1970” and forwards the message using Topic B1 with the subject matter “all cars from 1940-1980”. Any messages from Topic A1 passing through Topic B1 are wrapped in a message from Topic B1 indicating the immediate source of the message (e.g. Topic B1 is forwarding the attached message from User A's Topic A1). User C may further filter Topic B1's wrapper message using Topic B1's subject matter of “all cars from 1940-1980” and any other attributes available for 1980's post (shown as A1″) based on their topic rules. By encapsulating Topic A1's message in Topic B1's message, the trust relationship and rules between Topic B1's and their subscribers are preserved.

In a third example Rule 4 scenario, User A creates a rule to prevent non-subscribers from viewing messages sent by Topic A1. User B creates a rule that takes any arriving message from Topic A1 and forwards it using Topic B1. The gateway on Topic B1 processes the rules specified by User A and the forward message to User C, a non-subscriber to User A, is not generated. User D manually forwards Topic A1's message to User C and User D receives an error message (or a custom error provided by User A) and the message is not sent. User C navigates to User A's Topic A1 and no messages from Topic A1 are visible. User A may provide welcome messages or instructions to unsubscribed visitors.

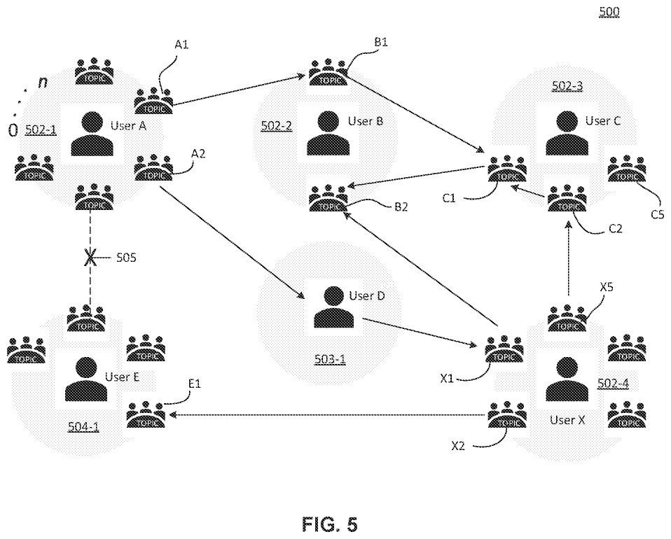

FIG. 5 is a flowchart for a micro-forum network 500, according to an embodiment. It is to be appreciated that not all steps shown may be needed to perform the disclosure provided herein. Further, some of the steps may be performed simultaneously, or in a different order than shown in FIG. 5, as will be understood by a person of ordinary skill in the art.

Each micro-forum includes one or more topics that act as subscription-based network nodes. As shown in FIG. 5, each micro-forum may attempt to subscribe to any other node that is currently accepting subscribers. In some embodiments, the micro-forum nodes may take different forms and functionality. In a non-limiting example, each micro-forum node may be a micro-forum 502 (1-4) implementing one or more topics, a micro-forum 503-1 without topics (e.g., only functioning as a data repository/relay), or a micro-forum with no subscribers 504-1, limited to only receiving new content updates. Each micro-forum may be subsequently configured to include the functionality of any of these described configurations. For example, a micro-forum can add or remove one or more forum topics and each topic node may be subscribed to by one or more other micro-forums.

In a non-limiting example, micro-forum 502-1 may be directly subscribed to by micro-forum nodes 502-2 Topic B1 and 503-1. Alternatively, or in addition to, micro-forum nodes may be indirectly connected with intermediary topic nodes acting as relays. For example, micro-forum 502-3 is indirectly connected to 502-1 through intermediary node 502-2 Topic B1. Data messages from Topic A1 flow to Topic B1 and then are relayed to Topic C1. In another non-limiting example, node 502-4 subscribes to micro-forum 502-1 through a subscription to 503-1. As shown, User E's micro-forum node 504-1 has a subscription to micro-forum node 502-4 Topic X2, but is not currently subscribed to by any other node, or has been unsubscribed voluntarily or involuntarily. For example, the owner of micro-forum 502-1, User A, may have decided to unsubscribe (505) node 504-1 based on a failure of node 504-1 to adhere to the rules of micro-forum 502-1 or their micro-forum node may have been automatically unsubscribed based on these rules. Alternatively, or in addition to, User E may withdraw or inactivate their existing subscription(s).

In some embodiments, users may want to have a first topic that receives subscribed data only, while also maintaining a second related topic that also receives the subscribed data, but may also contain original content created by that user. For example, as shown, User C (node 502-3) subscribes to Topic X5 by a connection to Topic C2. Topic C2 is further subscribed to within User C's own micro-forum 502-3 by Topic C1.

In some embodiments, users may want to have a first topic that receives subscribed data from multiple other micro-forums. In this embodiment, a user subscribes a topic on their micro-forum to multiple other micro-forums. As shown, User B's micro-forum 502-2 includes Topic B2 that subscribes to both Topic C1 and Topic X1. In this embodiment, Topic B2 will include at least the aggregated content forwarded by Topics C1 and X1 and may also include any additional content originated by User B. However, in some embodiments, a micro-forum user may also regulate, by rules, whether a downstream micro-forum may alter or edit the original content that they receive.

In some embodiments, interconnected topics are the same topic. In some embodiments, interconnected topics are similar topics. In some embodiments, interconnected topics are different topics that a user may desire to interconnect. In a non-limiting example, Topic C1 may be classic cars. In some embodiments, posted content from User C's classic car topic is automatically pushed to User B's same topic B2. User A would to subscribe to User B's Topic B2 to receive the combined content from both micro-forums. In other words, User A would gain the benefit of posted content from any upstream micro-forum nodes with classic car content without even knowing that they exist. However, unlike other forums systems, the content posted at each micro-forum is controlled by each user, without allowing another user to hijack the topic. Additional controls include, but are not limited to, each content provider and subscriber can manually or automatically engage rules preventing transmission or reception of content that they do not approve of (e.g., outside the intended topic). At least two technical improvements are provided by this structure. One, instead of building content by allowing any user to post, followed by policing the content, each micro-forum can add to same or similar content, without unwanted superfluous content invading the topic space. Two, a user of a subscription connected micro-forum can obtain aggregated related topic content without ever being aware of or interacting with the original source.

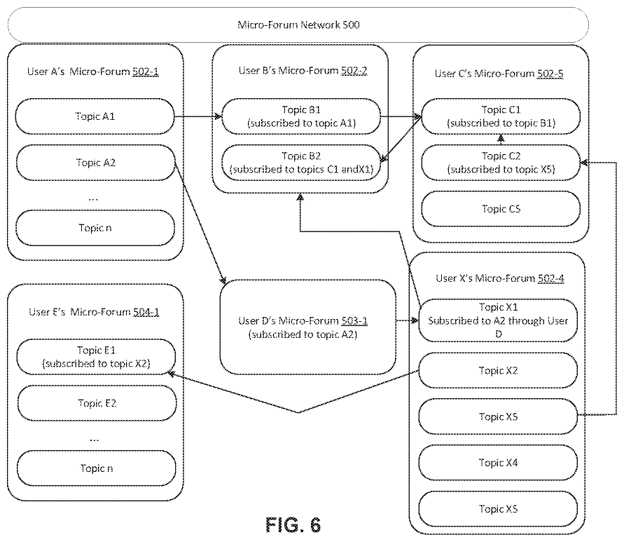

FIG. 6 is a flowchart for micro-forum network 500 operation, according to an embodiment. Micro-forum network 500 includes the micro-forums of FIG. 5 with subscription and content flows as shown. For example, Topic B1 subscribes to Topic A1 and will receive updates from Topic A1 as messages. The network shown includes a few examples of micro-forums, topics and subscriptions for simplicity purposes. However, it is envisioned that any number of micro-forums, topics, or subscribers may be interconnected without departing from the scope of the technology disclosed herein. Table 1, shown below, provides FIG. 5 subscription and message mappings for the limited micro-forum network.

TABLE 1

| User Micro-forums | Subscribes to: | Received message lists |
|---|---|---|
| User A | None | None |
| User B | Topics A1, C1, X1 | B1:A1, B2:C1, B2:X1 |
| User C | Topics B1, C2, X3 | C1:B1:A1, C1:C2:X3, C2:X3 |
| User D | Topics A2 | A2:A2 |
| User E | Topic X2 | E1:X2 |
| User X | Topic A2 (thru D) | X1:A2 |

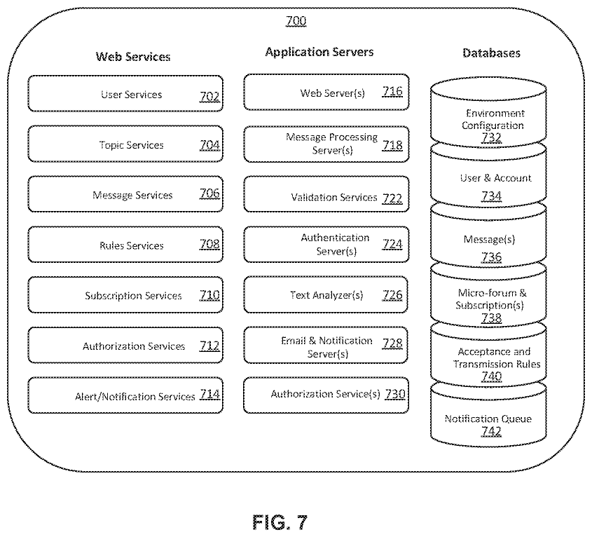

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

For illustrative purposes, the diagram shown in FIG. 7, may be based on a micro-forum product architecture 700. In this non-limiting embodiment, an example Web-based micro-forum services platform is shown and described. However, one skilled in the art will appreciate that other hardware or software platforms, services, servers, tasks, objects, storage designations and subscription measures may be substituted herein without departing from the scope herein.

Web services commonly provide an object-oriented Web-based interface to a database server, utilized for example by another Web server, or by a mobile app, that provides a user interface to the end-user. Many organizations that provide data in formatted Hyper-Text Markup Language (HTML) pages will also provide that data on their server as an Extensible Markup Language (XML) for storing, transmitting, and reconstructing arbitrary data. It defines a set of rules for encoding documents in a format that is both human-readable and machine-readable. In some embodiments, the Web services will be implemented as a collection of micro-services. A micro-service architecture is an architectural pattern that arranges an application as a collection of loosely-coupled, fine-grained services, communicating through lightweight protocols.

Example Web services will be described in greater detail below, but do not include all Web services available to a micro-forum platform. One skilled in the art will appreciate that additional Web services may be added to the micro-forum product architecture 700 without departing from the scope herein. User services 702 include, but are not limited to, a user account, user identifier, username (or user name), user profile, etc. Topic services 704 include, but are not limited to, a listing of topics, topic descriptions, topic keywords, topic filters, etc. Message services 706 include, but are not limited to, communication services between topic nodes, delivery confirmations, and delivery failure retry cycles, etc. Rules services 708 include, but are not limited to, rule templates to assist a user in developing their micro-forum rules sets, rule editors for rule changes or updates, rule enforcement, rule conflict determinations, etc. Subscription services 710 include, but are not limited to, processing of subscription requests, tracking current subscriptions, detection of subscription errors or of subscriber's failure to adhere to subscription rules, etc. Authorization services 712 include, but are not limited to, security between micro-forum nodes, evaluation of micro-forum identification parameters, and detection of unauthorized attempts to alter micro-forum structure, content or data. Alert/Notification services 714 include, but are not limited to, alert or notification messaging between micro-forum nodes. These alerts may be notifications that new content (e.g., messages) have been downloaded to a topic node, a request for subscription has been received, accepted or denied, etc.

Example application servers will be described in greater detail below, but do not include all application servers available to a micro-forum platform. One skilled in the art will appreciate that additional application servers may be added to the micro-forum product architecture 700 without departing from the scope herein. A Web server 716 consumes several Web services at different machines and compiles the content. A Web server 716 is computer software and underlying hardware that accepts requests via HTTP (the network protocol created to distribute web content) or its secure variant HTTPS. A user agent, commonly a web browser or web crawler, initiates communications by making a request for a web page or other resource using HTTP, and the server responds with the content of that resource or an error message. A web server can also accept and store resources sent from the user agent if configured to do so. The hardware used to run a Web server can vary according to the volume of requests that it needs to handle. At the low end of the range are embedded systems, such as a router that runs a small Web server as its configuration interface. A high-traffic Internet website might handle requests with hundreds of servers that run on racks of high-speed computers.

Message processing server(s) 718 include, but are not limited to, processing of messages between subscription-connected micro-platform topic nodes. Validation services 722 include, but are not limited to, security measures, such as encryption to ensure security of communications to/from or within the platform. Authentication server(s) 724 include, but are not limited to, user login script processing or other entity confirmation processes. Test Analyzer servers 726 include, but are not limited to, servers that recognize text, such as natural language processors (NLPs). The text analyzer servers may be used for topic searching, content processing, rules processing, etc. Email and Notification server(s) 728 include, but are not limited to, processing of email communication between micro-forum nodes, processing and communication of notifications, or for product assistance for new or existing users. Authorization services 730 include, but are not limited to, servers to process or enforce rules between micro-forum nodes.

Example databases will be described in greater detail below, but do not include all databases available to a micro-forum platform. One skilled in the art will appreciate that additional databases may be added to the micro-forum product architecture 700 without departing from the scope herein. A database is an organized collection and repository for data that may be stored and accessed electronically. Small databases can be stored on a file system, while large databases are hosted on computer clusters or cloud storage. The design of databases spans formal techniques and practical considerations, including data modeling, efficient data representation and storage, query languages, security and privacy of sensitive data, and distributed computing issues, including supporting concurrent access and fault tolerance. A database management system (DBMS) is the software that interacts with end users, Web services, application servers and the database itself to capture and analyze the data. The DBMS software additionally encompasses the core facilities provided to administer the database.

Environment configuration database 732 stores the micro-forum network configuration including, but are not limited to, data that captures listings and descriptions of connected micro-forum nodes, communication configurations, and topics nodes. User and Account database 734 includes, but is not limited to, a repository of user profile and account data. Message database 736 includes, but is not limited to, a repository of messages between micro-forum nodes, user messages, system messages, etc. Micro-forum and Subscriptions database 738 includes, but is not limited to, a repository of current micro-forums, subscribers, and subscriptions, previous micro-forums and subscribers, and historical data of the micro-forums and subscribers. Acceptance and transmission rules database 740 includes, but is not limited to, listing of micro-forums, accepted subscribers, and respective rule sets. Notification Queue database 742 includes, but is not limited to, a repository of notifications or alerts communicated in the micro-forum network or staged (queued) for future communications.

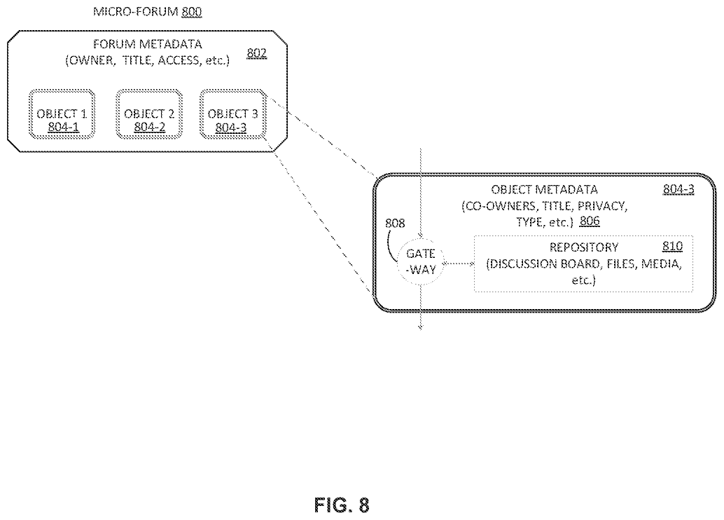

FIG. 8 is a high-level view of a micro-forum 800, according to an embodiment. Micro-forum 800 can be performed by processing logic that can comprise hardware (e.g., circuitry, dedicated logic, programmable logic, microcode, etc.), software (e.g., instructions executing on a processing device), or a combination thereof. It is to be appreciated that not all components may be needed to perform the disclosure provided herein. Further, some of the components may be in a different order than shown in FIG. 8, as will be understood by a person of ordinary skill in the art.

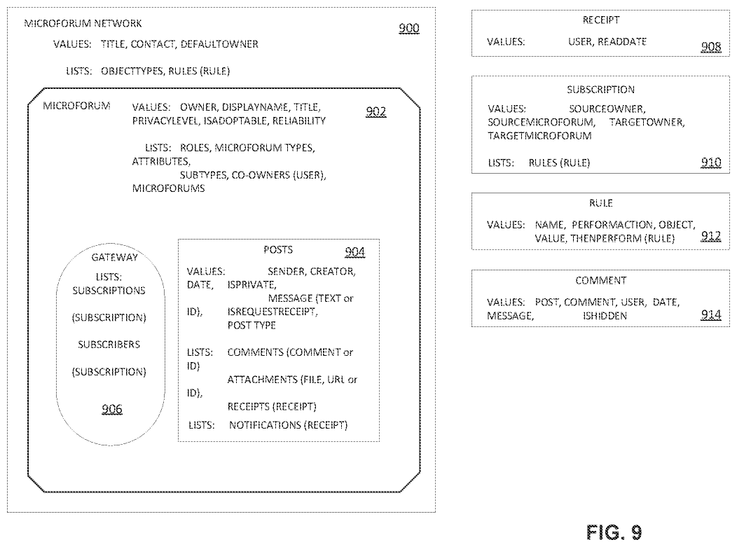

As shown, micro-forum 800 includes forum metadata 802 that describes the contents and/or context of the micro-forum, such as, but not limited to, security values (such, owner, access rights), display values (such as, title and owner name), default values for posts (such as, default visibility of posts, default category), etc. Micro-forum 800 may be configured with one or more objects 804 (objects 1-3). Objects contain the micro-forum children 122 and identifiable entities that have a set of attributes, behavior and state. An object breakout 804-3 of Object 3 illustrates that an object includes object metadata 806 that may include, but is not limited to, display information (such as, name, description, owner name, style, post template/type etc.), filtering and data-mining values (such as, micro-forum type, category, region, keywords, etc.), routing information (such as, subscriptions, rules, etc.), access control values (such as, privacy level, co-owners, white lists, black lists, etc.). The object may function as a node for the topic(s) 102 that functions as a gateway 808 to propagate content updates (e.g., messages) to other downstream subscribers. In addition, the object may function as a repository 810 for incoming messages, files, and media, etc. to be displayed as posts 116 on a discussion board to users. The micro-forum and object(s) will be described in greater detail in FIG. 9.

FIG. 9 is a detailed view of a micro-forum object 902 within a micro-forum network 700, according to an embodiment. Micro-forum network 900 can be performed by processing logic that can comprise hardware (e.g., circuitry, dedicated logic, programmable logic, microcode, etc.), software (e.g., instructions executing on a processing device), or a combination thereof. It is to be appreciated that not all components may be needed to perform the disclosure provided herein. Further, some of the components may be in a different order than shown in FIG. 9, as will be understood by a person of ordinary skill in the art.

FIG. 9, showing the micro-forum network 900 and micro-forum object 902, illustrates components and data types stored that are not to be considered as an exhaustive list. As shown, micro-forum network 900, micro-forum 902, micro-forum posts/messages 904 and gateway objects 906 are nested and therefore provide data and security advantages. Each parent object defines attributed and configurations used to describe the child objects. For example, a micro-forum network 900 may choose to define attributes of their micro-forum as “Software”, “Server”, and “Middleware”. This will allow their users to create micro-forums like “Accounting is Software”, “CUSTDB_API is Middleware”, “SA101 is a Server”. Dependencies can then be defined as “Accounting software depends on CUSTDB_API middleware which is hosted on SA101 server” and messages can be routed using “Posts from SA101 can be routed from CUSTDB_API to Accounting”. This structure provides a platform for data-mining operations to answer questions like “How many applications are dependent on SA101 server?” or “How many users are impacted by the new middleware upgrade?” Micro-forums 902 define the attributes available for gateways 906, such as lists of subscriptions and the corresponding subscribers. While shown as a few subscriptions, each micro-forum 902 may have an unlimited number of subscriptions/subscribers. Similarly, micro-forums 902 define the attributes available for Posts/Messages 904, such as, but not limited to, sender, creator, date, privacy, message text or id, receipt requests, and post type (e.g., template to apply on the message; types include, but not limited to, forum post, alert, survey, image grid, check list or document list, etc.). In addition, post/messages 904 provide list attributes, such as, but not limited to, comments, attachments, receipts and notifications. These attributes provide a structure for users to instruct the gateway 906 to use attributes to organize and direct incoming and outgoing messages. In a non-limiting example, a post from Server “SA101” with an attribute of “Red Alert—Server failure!” can provoke a different response than a simple “Routine maintenance successful” message.

In terms of security, this structure forces messages to pass through several checkpoints. For example, in some embodiments, each object stores relevant information regarding displaying, describing, securing, and verifying the data it contains, where the micro-forum network 900 protects its terms and condition level. Similarly, the micro-forum 902 protects its owner's interest and a post/message 904 protects its sender's interest. In some embodiments, objects can control the visibility of a post/message, such as, the sender at that post/message level, the recipient at the micro-forum 902 level, while the micro-forum network can prevent visibility at the network level if the post/message violates micro-forum network 900 rules. FIG. 9 also illustrates a security component for the micro-forum 902 object though gateway 906, which uses subscriptions similar to a whitelist/blacklist to decide what posts/messages are posted or forwarded to its owner.

Additional object and associated parameters include, but are not limited to, receipts 908 for messages received, subscriptions 910, rules 912 and comments 914. Receipts 908 include, but are not limited to, attributes of user and read date. Subscriptions 910 include, but are not limited to, attributes of source owner, source micro-forum, target owner, target micro-forum and lists of rule(s). Rules 912 include, but are not limited to, attributes of values of name, perform action, object, value, and then perform (rule). Comments 914 include, but are not limited to, attributes of values of post, comment, user, date message and hidden or not hidden.

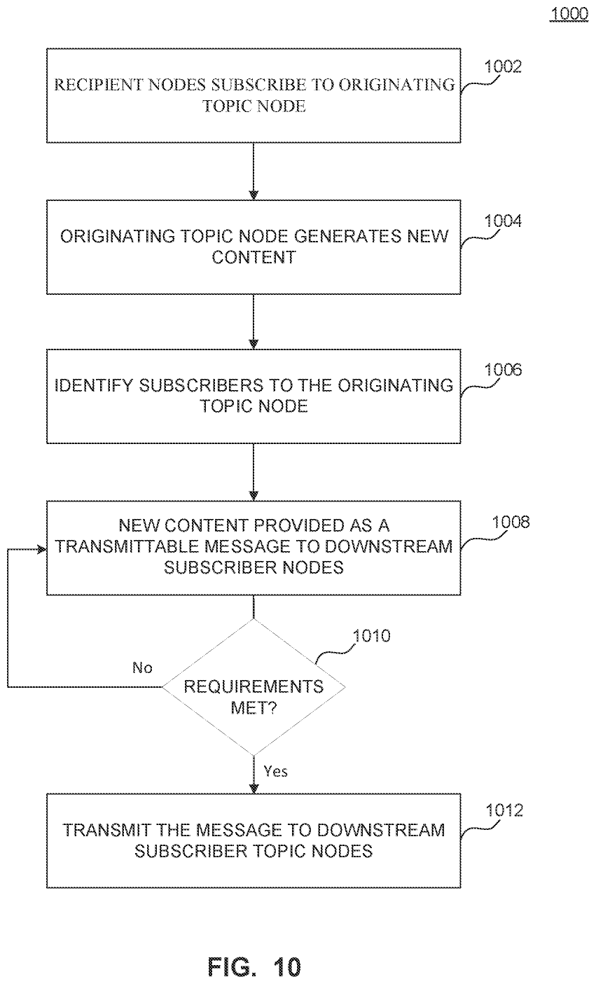

FIG. 10 is a flowchart for a method 1000 for a micro-forum topic node, according to an embodiment. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIG. 10. However, method 1000 is not limited to that example embodiment.

In 1002, a micro-forum node (recipient node) sends a subscription request message to a prospective topic node (originating node) requesting to become a subscriber. The message is sent to a message service which validates the requestor's credentials. Based on rules of the prospective topic node, the micro-forum node may be accepted as a subscriber.

In 1004, the prospective topic node generates (e.g., posts) updated or modified content within their topic node. For example, an owner of the micro-forum posts new content to the topic node.

In 1006, the topic node micro-forum identifies all subscribers to the topic node and for each identified subscriber, checks the transmission requirements for the sender node toward the specific recipient node (for example, is this recipient blocked) and acceptance requirements for the recipient node.

In 1008, the prospective topic node provides the new content as a transmittable message to downstream subscribers. The message is checked against rules of the micro-forum by a message service to pass prerequisite requirements.

In 1010, the message service sends the message to a message processing server. The message processing server checks to see if the message meets the requirements of the network, for example, quotas, terms of service, message sizes, or message transmission speeds, etc. The message service also determines, based on acceptance rules of the micro-forum nodes subscribing to the topic node, how the message should be handled when received, for example, should the message be hidden, private, blocked, redirected or replaced.

In 1012, if both the sender node and recipient node agree to transmit/receive the message, a copy of the message is added to the recipient nodes message list and a notification is sent to the recipient. If the recipient node also has subscribers to their topic node that receive the message, a new request is sent to the message processing server for a new copy of the message to be transmitted downstream to its subscribers. In some embodiments, post-processing is performed, such as, updating of quotas, audit trails, etc.

The various embodiments described provide an improvement to the computer system itself by. Unique features of the disclosed technology describing a micro-forum network include, but are not limited to:
The micro-forum network is non-hierarchical. Each micro-forum and owner can be a content originator or subscriber in the network.
Forum topics are dynamic and complex structures containing multiple topic related content and data, such as topic page, archival data, file and attachments lists.
Messages travel from forum topic node to forum topic node. This allows messages to stay “on topic” and relevant as they pass through the network.
A message may take unique and multiple routes between sender and recipient nodes. Any successful routes will deliver the message to the recipient. If a message is not successfully delivered, recipients and others can still access the message through a micro-forum topics page, search requests, notifications, and advertisement of topics or suggestions.
Recipients control whether a message reaches its destination.
Topic are determined by individual users who personalize their micro-forum to meet their needs, maximizing their comfort level with their space and promote content creation
The system is topic-based, allowing for easy retrieval
Content is maintained, scrubbed, and organized by individual owners, minimizing the stress and need for oversight
Topic-based messages are a targeted broadcast to subscribers and stay correlated
If there are inaccuracies in the topic correlation or unwanted content, users have the power to make corrections in real-time because they own their personal space
No personal data required to deliver targeted messages
Administrative users control validation and settings for the network. As micro-forums are private spaces controlled by their respective owners, maintenance is the responsibility of the users who best know and understand the topic
The micro-forum network builds a structure between forum topics which may be mined for dependencies, exploration opportunities and change impact (e.g., discovering hidden dependencies and relationships), not owner or user data or histories.

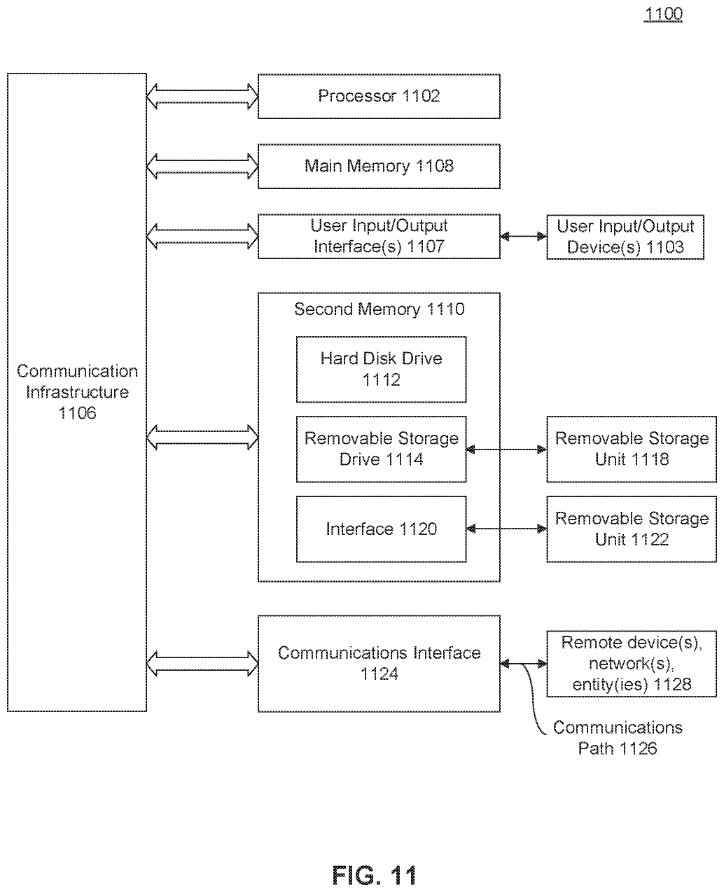

Various embodiments can be implemented, for example, using one or more computer systems, such as computer system 1100 shown in FIG. 11. Computer system 1100 can be used, for example, to implement method 1000 of FIG. 10 or any other methods or processes described herein. Computer system 1100 can be any computer capable of performing the functions described herein.

Computer system 1100 can be any well-known computer capable of performing the functions, steps, operations, methods, etc., described herein.

Computer system 1100 includes one or more processors (also called central processing units, or CPUs), such as a processor 11011. Processor 11011 is connected to a communication infrastructure or bus 1106.

One or more processors 1102 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 also includes user input/output device(s) 1103, such as monitors, keyboards, pointing devices, etc., that communicate with communication infrastructure 1106 through user input/output interface(s) 1107.

Computer system 1100 also includes a main or primary memory 1108, such as random access memory (RAM). Main memory 1108 may include one or more levels of cache. Main memory 1108 has stored therein control logic (i.e., computer software) and/or data.

Computer system 1100 may also include one or more secondary storage devices or memory 1110. Secondary memory 1110 may include, for example, a hard disk drive 1112 and/or a removable storage device 1114. Removable storage drive 1114 may be a floppy disk drive, a magnetic tape drive, a compact disk drive, an optical storage device, tape backup device, a cloud drive and/or any other storage device/drive.

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 reads from and/or writes to removable storage unit 1118 in a well-known manner.

According to an exemplary embodiment, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, etc. Control logic and/or data may be transmitted to and from computer system 1100 via communication path 1126.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but each embodiment need not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving, by a computer system, a request message to subscribe to an originating node of a first micro-forum, wherein the first micro-forum is operative within a micro-forum network and wherein the originating node is configured with a first topic, and wherein the first micro-forum is configured with one or more rules to at least process the request message to subscribe;
receiving, by the computer system, a topic message to be transmitted to a recipient node within a second micro-forum operative within the micro-forum network, wherein the recipient node comprises a subscriber based on an acceptance of the request message to subscribe, and wherein the topic message comprises modified content from the first topic;
receiving, by the computer system and based on the one or more rules, transmission parameters for the originating node to transmit the topic message to the recipient node of the subscriber, wherein the recipient node includes a second topic;
receiving, by the computer system, acceptance parameters for the recipient node to receive the transmitted topic message;
transmitting, by the computer system and based on a match of the transmission parameters and the acceptance parameters, the topic message, wherein the topic message is to be retained in the second topic of the recipient node; and
transmitting, by the computer system, a notification of the topic message sent to the recipient node.

2. The method of claim 1, further comprising, transmitting the request message to subscribe to a validation service to validate credentials of the recipient node.

3. The method of claim 2, further comprising transmitting the request message to a message service to determine if the request message meets requirements of the micro-forum network.

4. The method of claim 3, wherein the requirements of the micro-forum network comprise any of: quotas, terms of service, message sizes, or message transmission speeds.

5. The method of claim 1, wherein the acceptance parameters for the recipient node comprise handling the message within the recipient node based on any of: adherence to recipient node rules, previous historical interactions with one or more of the micro-forums, or message status.

6. The method of claim 5, wherein the message status comprises any of: hidden, private, blocked, redirected, ignored, or replaced.

7. The method of claim 1, further comprising identifying additional subscribers of the originating node of the first micro-forum and transmitting the topic message to each of the identified additional subscribers.

8. The method of claim 1, further comprising identifying subscribers to the recipient node of the second micro-forum and transmitting the topic message to each of the identified subscribers.

9. The method of claim 1, wherein the acceptance requirements for the recipient node comprise any of: message is blocked, message is a duplicate, or filter parameters.

10. The method of claim 1, wherein the first topic and the second topic are the same topic.

11. The method of claim 1, wherein the first topic and the second topic are similar based on any of: title, topic description, topic keywords, or rules of the recipient node.

12. A system, comprising:
a memory; and
at least one processor coupled to the memory and configured to:
receive a request message to subscribe to an originating node of a first micro-forum, wherein the first micro-forum is operative within a micro-forum network and wherein the originating node is configured with a first topic, and wherein the first micro-forum is configured with one or more rules to at least process the request message to subscribe;
receive a topic message to be transmitted to a recipient node within a second micro-forum operative within the micro-forum network, wherein the recipient node comprises a subscriber based on an acceptance of the request message to subscribe, and wherein the topic message comprises modified content from the first topic;
receive, based on the one or more rules, transmission parameters for the originating node to transmit the topic message to the recipient node of the subscriber, wherein the recipient node includes a second topic;
receive acceptance parameters for the recipient node to receive the transmitted topic message;
transmit, based on a match of the transmission parameters and the acceptance parameters, the topic message, wherein the topic message is to be retained in the second topic of the recipient node; and
transmit a notification of the topic message sent to the recipient node.

13. The system of claim 12, wherein the recipient node serves as a gateway for subsequent transmission of the topic message to downstream subscriber nodes of the recipient node.

14. The system of claim 12, the at least one processor further configured to: direct handling of the message within the recipient node based on the acceptance parameters for the recipient node comprising any of: adherence to recipient node rules, previous historical interactions with one or more of the micro-forums, or message status.

15. The system of claim 12, the at least one processor further configured to: identify additional subscribers to the originating node of the first micro-forum and transmit the topic message to a node of the identified additional subscribers.

16. The system of claim 12, the at least one processor further configured to: identify subscribers to the recipient node of the second micro-forum and transmit a copy of the topic message for each of the identified subscribers.

17. The system of claim 12, wherein a similarity of the first topic and the second topic is determined based on any of: title, topic description, topic keywords, or rules of the recipient node.

18. A non-transitory computer-readable device having instructions stored thereon that, when executed by at least one computing device, cause the at least one computing device to perform operations comprising:
receiving a request message to subscribe to an originating node of a first micro-forum, wherein the first micro-forum is operative within a micro-forum network and wherein the originating node is configured with a first topic, and wherein the first micro-forum is configured with one or more rules to at least process the request message to subscribe;
receiving a topic message to be transmitted to a recipient node within a second micro-forum operative within the micro-forum network, wherein the recipient node comprises a subscriber based on an acceptance of the request message to subscribe, and wherein the topic message comprises modified content from the first topic;
receiving, based on the one or more rules, transmission parameters for the originating node to transmit the topic message to the recipient node of the subscriber, wherein the recipient node includes a second topic;
receiving acceptance parameters for the recipient node to receive the transmitted topic message;
transmitting, based on a match of the transmission parameters and the acceptance parameters, the topic message, wherein the topic message is to be retained in the second topic of the recipient node; and
transmitting a notification of the topic message sent to the recipient node.

19. The non-transitory computer-readable device of claim 18, wherein the operations are further configured to identify additional subscribers to the originating node of the first micro-forum and transmit the topic message to a node of the identified additional subscribers.

20. The non-transitory computer-readable device of claim 19, wherein the operations are further configured to identify subscribers to the recipient node of the second micro-forum and transmit a copy of the topic message to a node of each of the identified subscribers.
